(19) United States
(12) Patent Application Publication
(10) Pub. No.: US 2008/0004957 A1
(43) Pub. Date: Jan. 3, 2008

(54) Targeted advertising for portable devices

(75) Inventors: Robert Hildreth, Bellevue, WA (US); Darren R. Davis, Woodinville, WA (US); Ryan A. Haveson, Monroe, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/477,636

(22) Filed: Jun. 29, 2006

(51) Int. Cl. G06Q 30/00

(52) U.S. Cl. 705/14

(57) ABSTRACT

Portable devices and networked servers are configured to implement aspects of an advertising system, which arranges for certain digital advertising content to be asynchronously received by a portable device separate from program content. The portable device is configured to receive digital data via two or more communication networks. Predetermined network selection criteria are used to select one or more communication networks from among the two or more communication networks via which the portable device is configured to receive digital data. Advertising content is packetized in accordance with a predetermined packet data communication protocol, and the data packets are asynchronously transmitted via the selected communication network(s). The portable device is able to re-construct the advertising content based on the packet data communication protocol, to request updates of the digital advertising content, and to capture consumption data, which is usable for numerous purposes.

### BACKGROUND

Advertising is often embedded within digital video or audio content (“program content”) broadcast by entities such as cellular network operators, cable network operators, satellite network operators, hosts of Internet services, over-the-air broadcasters, and others. Embedded advertising generally reaches large audiences and is a source of revenue for broadcasters, but also suffers from various limitations. Sometimes, insurmountable challenges are encountered when it is desirable to use one or more of the following advertising techniques in conjunction with embedded advertising: targeting specific advertising to individual people or devices; implementing interactive advertising features, such as the inclusion of a user-selectable visible or audible object in an advertisement; using advertising formats that are incompatible with formats of the program content (for example, embedding a video advertisement into audio program content broadcast by a radio network); or presenting up-to-date advertisements as recorded program content is played.

Advertising capabilities may be enhanced when advertising content is transmitted separately from program content. In the field of television programming one proposal for separating the transmission of advertising content from program content involves transmitting television program content to a person's home or business separate from television advertising content, and using an in-home device to coordinate the presentation of the television program content and the advertising content. Television, however, is only one source of program content, and in-home television receiving devices represent only a subset of the equipment used to present such program content.

People are spending an increasing amount of time using portable devices configured for playing digital media. Examples of such devices include but are not limited to mobile phones, personal digital assistants, personal computers, and personal audio or video players. Such portable devices are often equipped to access multiple wide-area networks (“WANs”) or local-area networks (“LANs”) using a wide variety of protocols and techniques, and networking opportunities are virtually ubiquitous. As such, people can receive program content from a variety of providers and/or network operators almost anywhere they happen to be.

It is desirable to provide an advertising system usable by, and commercially beneficial to, a variety of content providers, advertisers, network operators, and users of portable devices, via which digital advertising content is reliably distributed to targeted users separately from program content, and via which information regarding users' consumption of the digital advertising content may be collected.

It will be appreciated, however, that the claimed subject matter is not limited to implementations that solve any or all of the disadvantages of specific advertising services, systems or aspects thereof.

### SUMMARY

Aspects of the implementation and operation of an advertising system, which is usable in connection with portable devices and networked servers, are discussed herein. The discussed methods, systems, apparatuses, and articles of manufacture arrange for certain digital advertising content (such as digital advertisements or metadata) to be asynchronously received by a portable device separate from program content (if any) associated with the digital advertising content. Generally, the digital advertising content is received prior to the time at which it is scheduled for presentation, although transmission just-in-time for presentation is also possible. The portable device is configured to receive digital data via two or more communication networks. Examples of communication networks via which the portable digital medial receiver may be configured to receive digital data include but are not limited to: wide area networks such as General Packet Radio Service (“GPRS”)-enabled networks, Evolution Data Only (“EV-DO”)-enabled networks, Data Over Cable Service Interface Specification (“DOCSIS”)-enabled networks, the Internet, High Speed Downlink Packet Access (“HSDPA”)-enabled networks, Universal Mobile Telecommunication System (“UMTS”)-enabled networks, Enhanced Data rates for Global Evolution (“EDGE”)-enabled networks, wireless local area networks such as Wireless Fidelity (“WiFi”) networks; digital broadcast networks configured for datacasting (in accordance with specifications or techniques such as Digital Video Broadcasting-Handheld (“DVB-H”) or digital audio broadcasting (“DAB”), for example).

One aspect of the operation of the advertising system involves using predetermined network selection criteria to select one or more communication networks usable to transmit digital advertising content to a particular portable device. The communication network(s) are selected from among the two or more communication networks via which a particular portable device is configured to receive digital data. Examples of predetermined network selection criteria include but are not limited to static or dynamic network characteristics such as speed, availability, bandwidth, usage level, and usage cost, and static or dynamic characteristics associated with portable devices. Predetermined network selection criteria may be evaluated in the context of specific advertising delivery constraints, such as delivery time constraints or other constraints. In this manner, it is possible for digital advertising content to be concurrently delivered to a portable device over multiple networks—combinations of uni-directional or bi-directional networks supporting various communication standards or protocols may concurrently transmit digital advertising content to the same portable device.

Digital advertising content is generally packetized in accordance with a predetermined packet data communication protocol, and the data packets are asynchronously transmitted via the selected communication network(s). The portable device that receives the data packets is able to re-construct the digital advertising content based on the packet data communication protocol. The portable device is optionally configured to request updates of digital advertising content based upon the occurrence of certain triggers, such as upon being configured to receive digital advertising content, upon the detection of errors in the receipt of digital advertising content, or upon the expiration of digital advertising content.

Implementations of the advertising system discussed herein create, manage, or use data relating to the distribution of digital advertising. Examples of such data include but are not limited to: items of digital advertising content or locations thereof; advertising distribution criteria used to identify specific digital advertising content for presentation and/or when or to whom digital advertising content is transmitted or presented; network selection criteria used to identify the communication network(s) via which digital advertising content is transmitted; distribution session records, which summarize pertinent information about digital advertising content distributions; and advertising consumption data, which is obtained by monitoring user consumption of digital advertising content.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter.

### BRIEF DESCRIPTION OF THE DRAWINGS

FIG. 1 is a simplified functional block diagram of an architecture for distributing digital advertising content to a portable device via a number of communication networks.

FIG. 2 is a simplified functional block diagram of an advertising system, aspects of which are configured for implementation or operation with various components of the architecture shown in FIG. 1.

FIG. 3 is block diagram of a data packet, illustrating an exemplary encapsulation scheme used to format digital advertising content in accordance with a packet data communication protocol implemented by aspects of the advertising system shown in FIG. 2.

FIG. 4 is a flowchart illustrating certain aspects of a method for providing digital advertising content to a portable device.

FIG. 5 is a simplified functional block diagram of an exemplary configuration of an operating environment in which aspects of the system shown in FIG. 2 may be implemented or used.

### DETAILED DESCRIPTION

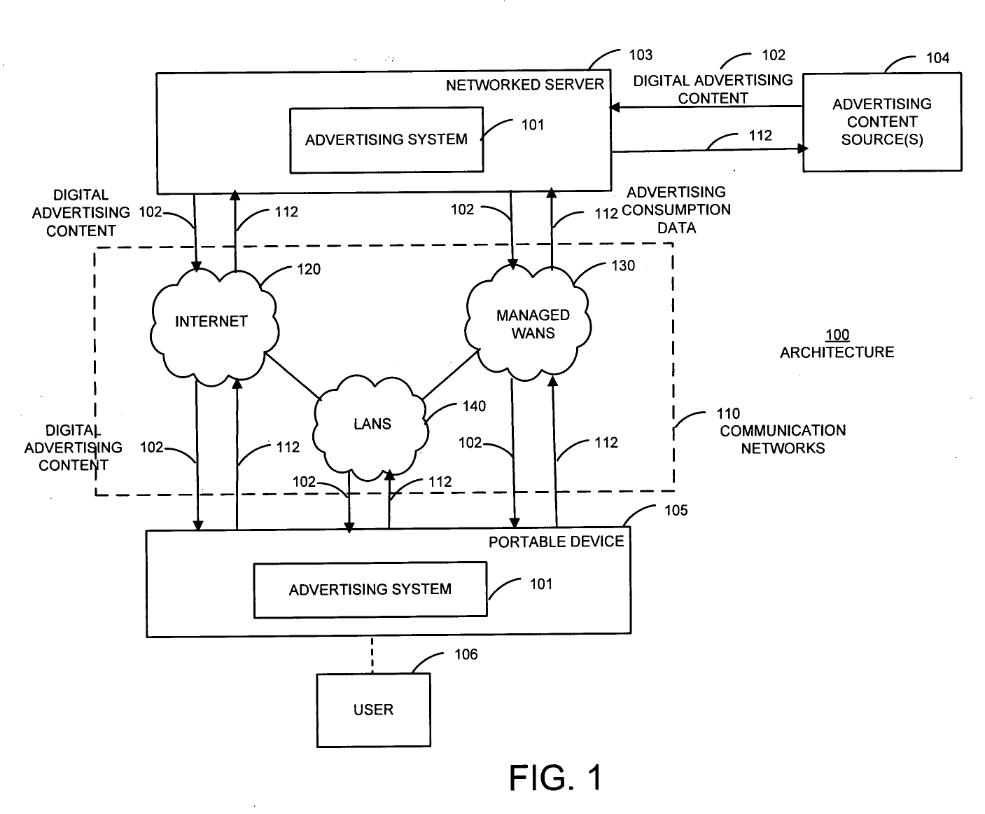

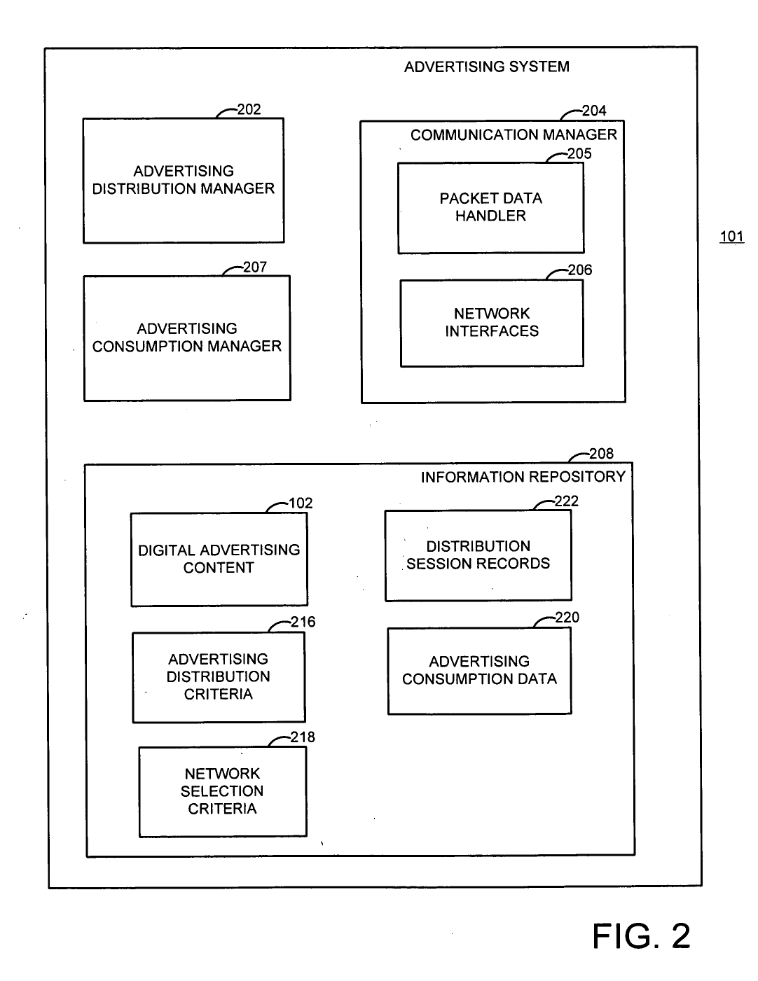

Turning to the drawings, where like numerals designate like components, FIG. 1 is a simplified functional block diagram of an architecture 100 that includes an advertising system 101 (functional components of advertising system 101 are shown and discussed in connection with FIG. 2). As shown, aspects of advertising system 101 are implemented by a networked server 103 and a portable device 105. Advertising system 101 handles the distribution of digital advertising content 102, which may be received from advertising content source(s) 104, to portable device 105 operated by user 106. Advertising system 101 also optionally handles the distribution of advertising consumption data 112, which is received from portable device(s) 105, to various destinations within architecture 100. Digital advertising content 102 and advertising consumption data 112 are distributed via one or more communication networks 110 (discussed further below).

Digital advertising content 102 represents digital advertisements and metadata associated with digital advertisements. Digital advertisements are generally digital media items or sets of digital media items, such as audio files, video files, text files, image files, multimedia files, interactive multimedia files, or data files. Metadata is any information, in any form or format, about the digital advertisements or information regarding the association(s) of digital advertisements with program content (if any) with which the digital advertisements are presentable. Examples of metadata include but are not limited to advertising source information, advertising targeting information, program content information (such as starting and ending times for program content and/or advertising insertion, or association of digital advertisements with program content), expiration date information, hyperlinks to websites, presentation schedule information, advertising duration, playback speed, file size information, and format information (such as recording rates, encoding formats, and the like). Digital advertising content 102 may exist in any available formats or protocols or combinations thereof, such as portable network graphics (“PNG”), joint photographic experts group (“JPEG”), moving picture experts group (“MPEG”), multiple-image network graphics (“MNG”), audio video interleave (“AVI”), extensible markup language (“XML”), hypertext markup language (“HTML”), extensible HTML (“XHTML”), MP3, WAV, WMA, WMV, ASF, or any format via which digital data may be provided in real-time or streamed.

Portable device 105 is any electronic device (or any physical or logical element of such an electronic device, either standing alone or included in other devices), which is configured to receive digital data, such as digital advertising content 102, from any combination of two or more communication networks I 10. Portable device 105 may be configured to render digital advertising content 102, or alternatively to pass digital advertising content 102 to a device configured to render digital advertising content 102. User 106 is a person authorized to operate portable device 105. Examples of portable devices 105 include but are not limited to mobile phones, personal digital assistants, personal computers, personal audio or video players, computer/television devices, set-top boxes, hard-drive storage devices, video cameras, DVD players, cable modems, local media gateways, and devices temporarily or permanently mounted in transportation equipment such as wheeled vehicles, planes, or trains.

Networked server 103 represents one or more processing locations within or accessible by communication networks 110, which host aspects of advertising system 101.

Collectively, communication networks 110 represent any set of two or more existing or future, public or private, wired or wireless, wide-area or local-area, packet-switched or circuit-switched, one-way or two-way digital data transmission infrastructures or technologies, operated by any type of network providers, which provide downstream transport for digital advertising content 102 directed to portable device 105. A packet-switched network routes packets of data between nodes of the network based on addresses of the nodes and/or destination addresses. In a circuit-switched network, a physical path or communication channel is dedicated to a connection between nodes. Several exemplary types of communication networks 110 are shown, including the Internet 120, managed wide area networks (“WANs”) 130, and local area networks (“LANs”) 140.

The Internet 120 is a system of computer networks/global information system that is logically linked together by a unique address space based on Internet Protocol (“IP”), and which is able to support communications using the Transmission Control Protocol/IP (“TCP/IP”) suite of protocols or other IP-compatible protocols.

Managed WANs 130 are publicly or privately operated, wireless or wired, packet-switched or circuit-switched, one-way or two-way geographically dispersed networks generally covering regions of more than a few hundred meters. Cellular networks, satellite networks, fiber-optic networks, co-axial cable networks, hybrid networks, copper wire networks, and over-the-air broadcasting networks such as television and radio networks are some examples of managed WANs 130. Internal arrangements, architectures and principles of operation of various types of managed WANs 130 are known. Such WANs 130 may use various protocols or techniques to provide encoding and/or downstream transport for digital advertising content 102 directed to portable device 105. Examples of such protocols or techniques include but are not limited to: Ethernet; IP; General Packet Radio Service (“GPRS”); Evolution Data Only (“EV-DO”); Data Over Cable Service Interface Specification (“DOCSIS®”); proprietary techniques or protocols; datacasting; or combinations thereof. High Speed Downlink Packet Access (“HSDPA”); Universal Mobile Telecommunication System (“UMTS”); Enhanced Data rates for Global Evolution (“EDGE”); Digital Video Broadcasting-Handheld (“DVB-H”); and digital audio broadcasting (“DAB”).

LANs 140 are publicly or privately operated, wireless or wired, packet-switched or circuit-switched, one-way or two-way networks that facilitate the transmission or receipt of information within relatively small physical areas surrounding a deviceor an entity such as portable device 105. One example of a LAN is a wireless LAN (“WLAN”), which is generally identified by the air interface protocol(s) used for communication within the WLAN. The Wireless Fidelity (“WiFi”) series of protocols and HiperLAN protocols are currently popular air interface protocols. WLANs are generally accessed by one or more access points (not shown), which may also be configured to enable communication via the Internet 120 or one or more managed WANs 130.

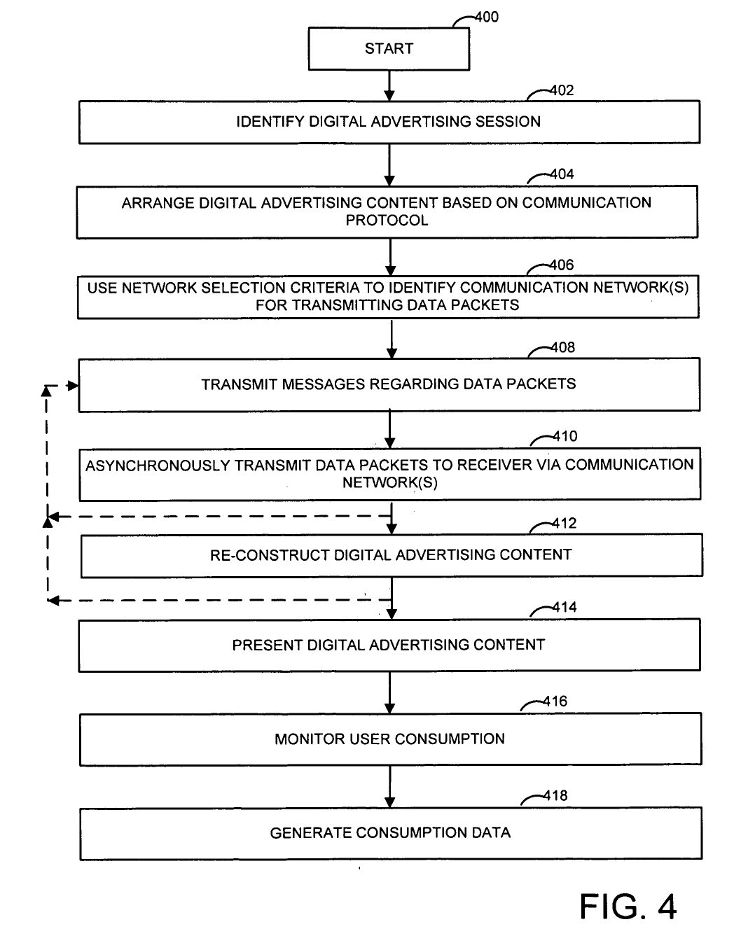

With continuing reference to FIG. 1, FIG. 2 is a simplified functional block diagram of an advertising system 101, aspects of which are usable with portable device 105 and networked server 103. Advertising system 101 includes: an advertising distribution manager 202; a communication manager 204, which further includes a data packet handler 205 and network interfaces 206; an advertising consumption manager 207; and an information repository 208. As shown, information repository, which represents general data storage capability for information, further includes information regarding various kinds of data created, managed, or used by components of advertising system 101, such as digital advertising content 102 (discussed above), advertising distribution criteria 216 (discussed in connection with advertising distribution manager 202), network selection criteria 218 (discussed in connection with communication manager 204), advertising consumption data 220 (discussed in connection with advertising consumption manager 207), and distribution session records 220 (discussed in connection with FIG. 4).

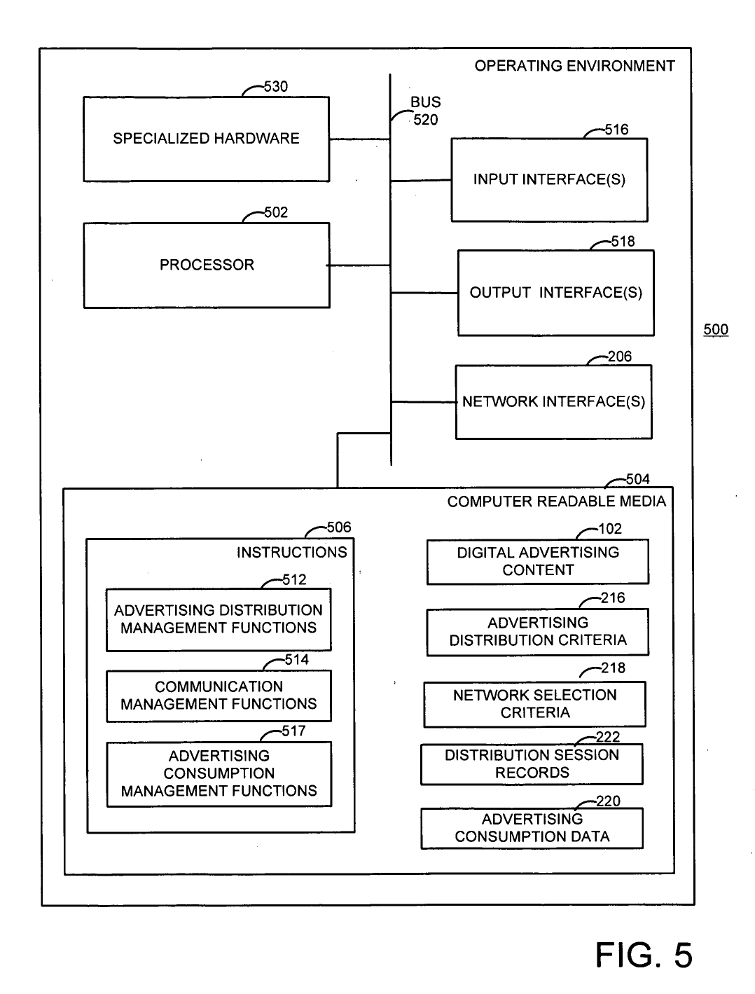

In general, design choices dictate how specific functions of Advertising System 101 are implemented, if at all. Such functions may be implemented using hardware, software, firmware, or combinations thereof. It will also be appreciated that implementations of the functions of advertising system 101 are tailored to the particular environment in which advertising system 101 operates (details of exemplary operating environments are discussed in connection with FIG. 5). For example, networked servers 103 may use certain functional implementations of advertising system 101, while portable device 105 may use other (generally complementary) functional implementations. Alternate implementations of the functional components of advertising system 101 are discussed below, based on whether the operating environment of a particular functional component is associated with networked server 103 or portable device 105.

Referring now to FIG. 2, advertising distribution manager 202 is responsible for (1) identifying digital advertising content 102 for distribution, and (2) determining when or to whom digital advertising content 102 is transmitted. Advertising distribution criteria 216 is generally used in connection with the functions of advertising distribution manager 202.

Advertising distribution criteria 216 include information usable for decision-making regarding distribution of digital advertising content 102 to portable device 105, or presentation of digital advertising content 102 to user 106 via portable device 105. Advertising distribution criteria 216 may be received from advertising content sources 104, pre-programmed into networked server 103 or portable device 105, generated by networked server 103 or portable device 105, or received from third parties (such as third party servers or service providers). Advertising distribution criteria 216 may also include expressions involving logical references to variables. Boolean operands such as “AND,” “OR,” and “NOT” , along with other operands or types thereof, may be used to define such expressions. It will be appreciated that virtually unlimited advertising distribution criteria 216 and combinations thereof are definable. Some specific types of advertising distribution criteria 216 are discussed below, and in connection with various components of Advertising System 101.

User profiles are one type of advertising distribution criteria 216. A user profile represents one or more collections of information about a particular user, in any format, stored in any location. User profiles are especially useful (often in conjunction with other advertising distribution criteria 216) for selecting digital advertising content 102 for presentation to users. On the network side, user profiles enhance targeting of advertisements to individuals or groups. On the client side, user profiles are useful for selecting advertisements for presentation to users. In one example applicable to both network-side and client-side operating environments, the user profile includes the current age of a user. Advertisements may be selected for presentation to the user based on his age, which changes over time. Certain general information within a user profile may be received directly from a user—for example, a user may input data into a portable device, or supply data to a network operator upon subscribing to use, or in connection with the use of, network resources. Other information within a user profile may be collected based on specific activities of the user with respect to Advertising System 101. In one example, certain information from distribution session records 222 (discussed in connection with FIG. 4) may be included in a user profiles. In another example, certain advertising consumption data 220 may form part of a user profile. To address privacy concerns, users may have control over whether and/or which information is collected and included in user profiles, and may also have control over how or by whom such information is used or accessed. User profiles are discussed further below, in connection with FIG. 4.

When the operating environment of advertising distribution manager 202 is networked server 103, the identification of particular digital advertising content 102 for distribution involves obtaining digital advertising content 102 from advertising content sources 104 and arranging digital advertising content 102 into sets of digital advertisements and associated metadata. Business rules (not shown) are examples of advertising distribution criteria 216 that are used to decide how digital advertising content 102 is obtained or arranged. Examples of business rules that are used to decide how digital advertising content 102 is obtained include but are not limited to rules specifying: when (or conditions under which) particular digital advertisements are available from advertising content sources 104; when (or conditions under which) particular digital advertisements expire; instructions for obtaining available digital advertisements (such as the whether the advertisements are pushed to advertising system 101 by advertising content sources 104 or are pulled by advertising system 101 from locations provided by advertising content sources 104 such as servers, data carousels, communication channels, and the like); and requests to advertising content sources 104 for digital advertisements having certain characteristics (such as advertisements for a particular piece of program content, or advertisements from a particular content source). Bundling rules are examples of business rules that are used to decide how digital advertising content 102 is arranged. Bundling rules reflect advertisers' preferences or restrictions regarding how digital advertisements are bundled together to form sets, to whom advertisements are targeted, with what program content advertisements are associated, and how and when advertisements are presented to a user. Business rules may be predetermined, or may be modified based on operation of Advertising System 101. For example, networked server 103 or portable device 105 may modify advertisement selection behavior based on information such as user profile information or advertising consumption data 222.

Regarding the responsibility of advertising distribution manager 202 to identify when or to whom digital advertising content 102 is transmitted, when networked server 103 provides the operating environment for advertising distribution manager 202, this responsibility involves associating sets of digital advertisements with advertising schedules and/or advertising targets, to form advertising distribution sessions. Advertising schedules are plans, organized in any fashion (for example, temporally or by subject matter) for distributing or presenting sets of digital advertisements or metadata. Advertising targets are individuals, particular portable digital media players, or groups thereof to which sets of digital advertisements or metadata are distributed. Predetermined targeting rules (not shown) are examples of advertising distribution criteria 216 that are used to form advertising distribution sessions. Examples of predetermined targeting rules include but are not limited to rules for organizing destination addresses associated with particular portable digital media players into groups based on demographic characteristics (such as geographic location, age, gender, media player characteristics, and the like) or other criteria; and rules for associating customized sets of digital advertisements with particular portable digital media players or groups thereof. Numerous advertising distribution sessions may be created for the same portable digital media device and/or the same sets of digital advertisements. A catalog or another type of data structure may be used to represent information about advertising distribution sessions.

When portable device 105 provides the operating environment for advertising distribution manager 202, the responsibility of identifying particular digital advertising content 102 involves obtaining digital advertising content 102 from advertising system 101 associated with networked server 103 via one or more communication networks 110. Specific details regarding the receipt and handling of digital advertising content 102 by portable device 105 are discussed in connection with communication manager 204 and FIG. 4. In general, however, digital advertising content 102 may be obtained automatically, or in response to a request from portable device 105. Requests for digital advertising content 102 from portable device 105 may be made for various reasons, such as upon the expiration of advertisements, initialization of advertising system 101, and detection of errors in the receipt of advertisements. In one implementation, digital advertising content 102 is pushed by networked server 103 to portable device 105. Alternatively, digital advertising content 102 is pulled by portable device 105 from a location specified by networked server 103.

Referring again to the advertising system of FIG. 2, communication manager 204 is discussed. Communication manager 204 is responsible for handling the transmission and receipt of information associated with advertising system 101 via communication networks 110. Packet data handler 205 is responsible for using a predetermined packet data communication protocol (discussed further below) in connection with the handling of information associated with individual advertising distribution sessions. Network interfaces 206 are responsible for using one or more protocols or techniques supported by communication networks 110 to enable communication between an advertising system implemented by networked server 103 and an advertising system implemented by a particular portable device. It will be understood that information received at a given network interface 206 may traverse one or more of the seven vertical layers of the OSI Internetworking Model: layer 1, the physical layer; layer 2, the data link layer; layer 3, the network layer; layer 4, the transport layer; layer 5, the session layer; layer 6, the presentation layer; and layer 7, the application layer.

When the operating environment of communication manager 204 is networked server 103, packet data handler 205 is responsible for (1) formatting digital advertising content 102 associated with specific advertising distribution sessions, and (2) selecting at least one communication network (from among two or more communication networks via which a particular advertising target is able to receive digital data) for transmission of digital advertising content 102 associated with specific advertising distribution sessions.

The responsibility of formatting digital advertising content 102 generally involves breaking up sets of digital advertisements and/or metadata associated with specific advertising distribution sessions into data units, and using a predetermined packet data communication protocol for creating data packets associated with the data units. In one possible implementation, the packet data communication protocol is an asynchronous transport layer protocol that includes a control component and a data encapsulation component. It will be appreciated, however, that communication protocols at other layers of the OSI Internetworking Model may also be used. It will also be appreciated that some digital advertising content 102 may be transmitted (streamed, for example) just-in-time for presentation to a user, rather than being pre-downloaded and cached.

The control protocol component of the packet data communication protocol is used to encapsulate relevant information about a specific advertising distribution session into messages (referred to as “control messages”) having predetermined formats. The messages are used to transfer relevant information about specific advertising distribution sessions between network-side advertising systems and client-side advertising systems. More specifically, the control protocol component is responsible for coordination of the distribution of encapsulated data over one or more networks. Examples of control messages include but are not limited to: messages used to initiate an advertising distribution session with one or more portable devices (referred to as “InitiateSession” messages); messages used to indicate that an advertising distribution session and/or the transfer of data units is complete (referred to as “TransmissionComplete” messages); messages used to indicate that the transfer of data units associated with sets of digital advertisements or metadata is beginning (referred to as “StartTransmission” messages); messages used to indicate that a particular advertising distribution session is incomplete (referred to as “FailedTransmission” messages); and messages used to end or to stop a particular advertising distribution session (referred to as “TerminateSession” messages). It will be appreciated that some messages may be generated by network-side Advertising Systems 101, some messages may be generated by device-side Advertising Systems 101, and some messages may be generated by either network-side or device-side Advertising Systems 101.

Within each type of message, one or more fields are used to identify pertinent information relating the distribution transaction. Examples of information/fields include but are not limited to: identifiers of specific session initiators (included in a field referred to as the “InitiatorID” field); identifiers of specific advertising distribution sessions (included in a field referred to as the “SessionID” field); destination addresses associated with individual portable devices (included in a field referred to as the “EndpointID” field); destination addresses accessible by groups of portable devices (included in a field referred to as the “GroupID” field); identifiers of specific sets of digital advertisements and/or metadata to be transmitted (included in a field referred to as the “DatasetID” field); information regarding the total number of data packets an advertising target should receive (included in a field referred to as the “TotalPackets” field); information regarding the starting number for the sequence of packets that the advertising target will receive (included in a field referred to as the “PacketSequenceStart” field); and information regarding packets that an advertising target did not receive (included in a field referred to as the “MissingPacketList” field).

Exemplary formats for various messages are set forth below. Although the messages shown have formats associated with extensible markup language (“XML”), it will be appreciated that the messages may have any format or representation desired. An exemplary format for an InitiateSession message, which is used to announce the establishment of a specific advertising distribution session to an advertising target, is illustrated below:

```
<InitiateSession>
  <InitiatorID> ... </InitiatorID>
  <SessionID>...</SessionID> | <GroupID> ... </GroupID>
  <EndPointID>...</EndPointID>
  <IntiatorID> ... </IntiatorID>
</InitiateSession>
```

An exemplary format for a StartTransmission message, which is used to indicate the beginning of the transmission of data packets containing data units associated with a particular set of digital advertisements, is illustrated below:

```
<StartTransmission>
  <SessionID>...</SessionID>
  < DatasetID> ... < /DatasetID>
  <TotalPackets> ... </TotalPackets>
  <PacketSequenceStart> ... </PacketSequenceStart>
</StartTransmission>
```

An exemplary format for a TransmissionComplete message, which is used to indicate that a particular session or transmission of data packets containing data units associated with a particular set of digital advertisements is complete, is illustrated below:

```
< TransmissionComplete>
  <SessionID>...</SessionID>
  < DatasetID> ... < /DatasetID>
</ TransmissionComplete>
```

An exemplary format for a FailedTransmission message, which is used to indicate that an advertising target did not receive a complete set of digital advertisements, is illustrated below:

```
<FailedTransmission>
  <SessionID>...</SessionID>
  < DatasetID> ... < /DatasetID>
  <EndPointID>...</EndPointID>
  <IntiatorID> ... </IntiatorID>
  <MissingPacketList> ... </MissingPacketList>
</FailedTransmission >
```

An exemplary format for a TerminateSession message, which is used to end or stop an advertising distribution session, is illustrated below:

```
<TerminateSession>
  <SessionID>...</SessionID>
  <EndpointID>...</EndpointID>
  <InitiatorID>...</InitiatorID/
</TerminateSession >
```

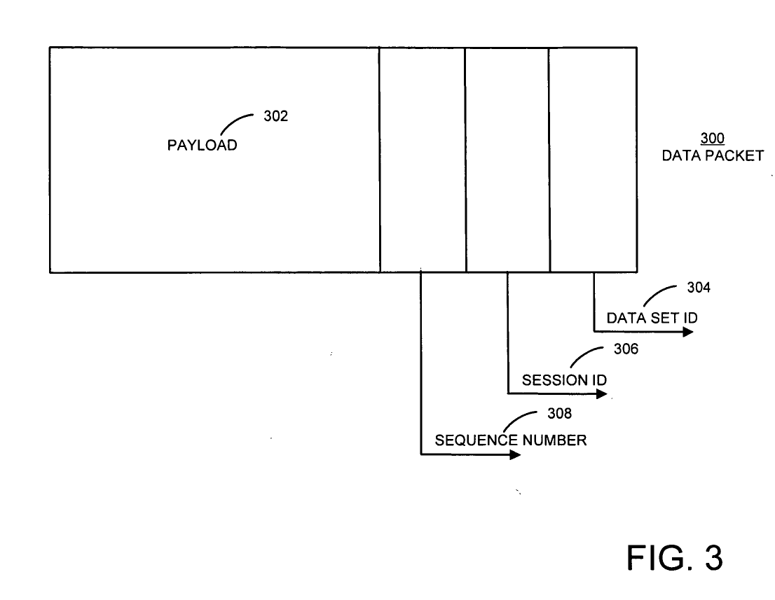

Referring again to the packet data communication protocol, FIG. 3 is a block diagram of an exemplary data packet 300, which is created by the data encapsulation component of the packet data communication protocol. Data packet 300 encapsulates data units of the broken-up sets of digital advertisements within payload field 302 of data packet 300. Dataset ID field 304 identifies sets of digital advertisements and/or metadata to be transmitted via a specific advertising distribution session. SessionID field 306 is used to identify the specific advertising distribution session. A sequence number field 308 is used to identify a sequence number associated with data packet 300. Data packets 300 and/or information encapsulated therein may be encrypted. It will be appreciated that the encapsulation scheme illustrated in FIG. 3 is exemplary in nature, and that other data packetization/encapsulation schemes are possible. Network interfaces 206 are responsible for the downstream transport of data packets 300 via one or more communication networks 110. Control messages may be transmitted over the same communication network(s) as data packets 300, or over different communication networks.

Referring again to FIG. 2, and to communication manager 204 implemented by networked server 103, the responsibility of selecting at least one communication network from among two or more communication networks via which a particular portable device is configured to receive digital advertising content 102 is discussed. Communication network selection generally involves evaluation of certain predetermined network selection criteria 218, which are generally adaptable heuristics used for decision-making regarding the selection of one or more communication networks 110. Generally, predetermined network selection criteria 218 facilitate the selection of communication networks 110 that will provide best-case transmission path(s) for digital advertising content based on metrics or algorithms that consider criteria such as dynamic or static network characteristics (for example, speed, availability, bandwidth, usage level, and usage cost), dynamic or static characteristics of portable devices (for example, the number of clients running on a particular portable device), and advertising delivery time constraints or other constraints. It will be appreciated that while the term “predetermined” is used in connection with network selection criteria 218, such network selection criteria 218 are not necessarily static, and may be modified over time, and even in real-time.

An exemplary format for describing various metrics associated with a particular a communication network for transmitting digital advertising content based on exemplary network selection criteria, is provided below. Although the metrics shown have formats associated with extensible markup language (“XML”), it will be appreciated that the messages may have any format or representation desired. The values of various communication networks may be compared to select one or more communication networks for transmitting digital advertising content.

```
<NetworkScore>
  <NetworkCost>
    <AccessRate>
      <CostPerBit>[cost per bit data] </CostPerBit>
      <CostPerTransaction[...]</CostPerTransaction>
      <StartTime>[start time for rate]</StartTime>
      <TimeBase> [Local | UTC ] </TimeBase>
      <Duration>[duration rate is valid]</Duration>
    </AccessRate>
    <AccessRate>
      ...
    </AccessRate>
  </NetworkCost>
  <NetworkAvailbility>
    <AccessPeriod>
      <StartTime>[start time for availability] </StartTime>
      <TimeBase> [ Local | UTC ] </TimeBase>
      <Duration> [duration period is valid] </Duration>
      <NetworkSpeed>[kbs] </NetworkSpeed>
    </AccessPeriod>
    <AccessPeriod>
      ...
    </AccessPeriod>
  </NetworkAvailbility>
  <BiDirectional> yes|no </BiDirectional>
  <NetworkType> [WAN | LAN | PAN | Broadcast] </NetworkType>
</NetworkScore>
<AdDeliveryRequirements>
  <DeliveryConstraints>
    <PreferredDeliveryTime> [Absolute Time Format]
    </PreferredDeliveryTime>
    <DiscardBy> [Absolute Time Format] </DiscardBy>
  </DeliveryConstraints>
</ AdDeliveryRequirements>
```

Referring again to FIG. 2, when the operating environment of communication manager 204 is portable device 105, network interfaces 206 are responsible for receiving inbound and outbound data packets created using the predetermined packet data communication protocol or other communication protocols. Outbound data packets may be transmitted via any network path or protocol. When communication manager 204 determines that content must be pulled from a network source specified by networked server 103 it is also responsible to select between two or more network interfaces 206. Implementation of the selection process is generally handled in like fashion to how implementations within the context of networked server 103 are handled.

Packet data handler 205 within portable device 105 is responsible for (1) handling (responding to, evaluating, creating, and optionally decrypting) control messages, and (2) re-constructing sets of digital advertisements or metadata (and confirming receipt of complete sets of digital advertisements or metadata) based on information within the control messages and data packets containing data units that are received via one or more communication networks 110. Packet data handler 205 may also optionally packetize advertising consumption data 220 (discussed below) in accordance with the predetermined packet data communication protocol. Delivery confirmation logic is generally used to verify that complete sets of digital advertisements or metadata were received, and to re-assemble data packets in the correct order using packet sequence numbers. No strict acknowledgement is generally required for individual data packet transfers, and data packets may arrive in any order. The delivery confirmation logic uses information received via control messages to determine if the transfer has been a success or a failure. Re-constructed sets of digital advertisements or metadata are generally stored in a computer-readable memory, such as a local data cache or another type of computer-readable memory (computer-readable memories are discussed further below, in connection with FIG. 5).

Digital advertising content 102 is cached and concatenated on portable device 105 based on advertising distribution criteria 216 (such as business rules or playback rules (discussed further below)) associated with the digital advertising content. Such advertising distribution criteria 216 may take the form of metadata transmitted as digital advertising content 102, or may be received in an alternative manner, such as from networked server 103, a third party, or retrieved from local storage.

Referring again to advertising system 101 shown in FIG. 2, advertising consumption manager 207 is responsible for (1) determining when or to whom digital advertising content 102 is presented, and (2) handling advertising consumption data 220. Generally, playback rules are types of advertising distribution criteria 216 that specify when, and to whom, certain digital advertising content 102 is played by portable device 105. Playback rules may be stored in any location (such as networked server 103 or portable device 105). Playback rules may be based on any desired information, such as advertising schedules, advertisement expiration dates, characteristics or actions of user 106, program content schedules, user profiles, advertising consumption data 220, and the like.

Advertising consumption data 220 is data obtained by monitoring user consumption of digital advertising content 102 distributed via advertising system 101. In the operating environment of portable device 105, advertising consumption manager 207 records information about when certain digital advertisements are played or re-played to user 106, along with information obtained via the interaction of user 106 with particular digital advertisements (such as user click-through). Advertising consumption data 220 may be used locally and/or transmitted (via any available communication network 110 using the predetermined packet data communication protocol or another communication protocol) to advertising system 101 within networked server 103 or to another location, such as an ad watch aggregation server or service.

Generally, advertising consumption data 220 is useful for selecting digital advertisements for presentation to users. Advertising consumption data 220 may also be used to update other types of advertising distribution criteria 216, such as user profiles (which are also useful in the selection of digital advertisements for presentation to users). For example, based on information regarding the type of advertisements that user 106 clicks-through (or bypasses), information may be obtained or inferred about user 106 and included in a user profile associated with user 106. On the network side, advertising consumption data 220 can enhance targeting of advertisements to individuals or groups. On the client side, advertising consumption data 220 can be used to select which advertisements are presented to users. Examples of advertising consumption data 220 and other device usage-based information useful for selecting digital advertisements include but are not limited to data relating to: user location (such as general geographic location or proximity to certain landmarks); program content preferences; payment preferences used in connection with a particular portable device; and general portable device usage (such as information regarding stored data or completed calls). Advertising consumption data 220 may be used for various other purposes, such as market research, forming business affiliations, or any other desirable purpose.

With continuing reference to FIGS. 1-3, FIG. 4 is a flowchart illustrating certain aspects of a method for distributing digital advertising content 102. The method illustrated in FIG. 4 may be implemented using computer-executable instructions executed by one or more general, multi-purpose, or single-purpose processors (exemplary computer-executable instructions 506 and processor 502 are discussed further below, in connection with FIG. 5). Aspects of the illustrated method may be performed by networked server 103 and/or portable device 105—for discussion purposes, FIG. 4 illustrates both client-side acts and network-side acts. Unless specifically stated, the methods described herein are not constrained to a particular order or sequence. In addition, some of the described method or elements thereof can occur or be performed concurrently. It will also be understood that all of the described steps need not occur in each advertising distribution session.

One advertising distribution session is discussed. It is assumed that portable device 105 is configured, and currently able, to receive digital data via the Internet using a WLAN and a GPRS-enabled cellular network as communication networks. In addition portable device 105 is configured to receive datacast information via a digital broadcast network such as a DVB-H-enabled broadcast network. It is also assumed that portable device 105 possesses or has acquired an EndpointID or a GroupID to serve as a destination address for data packets received via the WLAN, the GPRS-enabled cellular network, and the digital broadcast network. It will be appreciated that, in general, a particular device may have a unique address associated with each network. For example, a WiFi IP address may be different than a GPRS IP address. In the datacasting scenario, there may be no unique device address.

The method begins at block 400 and continues at block 402, where a digital advertising session is identified. For exemplary purposes, the digital advertising session is assumed to associate a single set of non-expired digital advertisements (which may include one or more digital advertisements and/or metadata) obtained from one or more advertising content sources 104 with portable device 105. In the context of advertising system 101, advertising distribution manager 202 implemented by networked server 103 is initially responsible for using advertising distribution criteria 216 such as business rules, advertising schedules, or predetermined targeting rules to associate the set of digital advertisements with a destination address associated with portable device 105. In one example of the use of advertising distribution criteria 216, more digital advertisements than needed may be included within the set of digital advertisements to be transmitted to portable device 105, so that portable device 105 may modify advertisement selection/delivery based on criteria such as historical consumption data 220 or information within a user profile associated with user 106.

Next, at block 404, digital advertising content is arranged based on a communication protocol. In the exemplary distribution session, the set of digital advertisements is broken up into appropriate data units, and transport layer data packets, such as data packets 300, are created based on the data encapsulation scheme provided by the data encapsulation component of the predetermined packet data communication protocol. In the context of advertising system 101, communication manager 204/packet data handler 205 implemented by networked server 103 is/are responsible for formatting the set of digital advertisements in accordance with aspects of the packet data communication protocol.

At block 406, network selection criteria are used to identify one or more communication networks via which data packets created at step 404 will be transmitted. In the exemplary distribution session, network selection criteria 218 are used to select at least one network from among the Internet facing communication networks (WLAN and GPRS-enabled cellular network) usable by portable device 105, and a DVB-H-enabled broadcast network. In the context of advertising system 101, communication manager/packet data handler 205 implemented by networked server 103 is/are responsible for evaluating an algorithm or metric for assessing suitability of relevant communication networks for transmitting the data packets based on network selection criteria 218, and for selecting one or more communication networks for transmitting the data packets. For example, if an inexpensive high-speed network such as a WiFi connection to-the Internet is available, the data packets may all be transmitted over that network. Alternatively, if an inexpensive high-speed network is not available, the data packets may be transmitted over multiple networks to achieve an acceptable tradeoff between network cost and speed. If no network or combination of networks is available that meet the predetermined performance criteria, then transmission of the data packets may be delayed. If the transmission delay results in the expiration of some or all of the digital advertisements within the set of digital advertisements, then, advertisements may be obtained, and the set of digital advertisements may be re-packetized.

Messages, such as control messages, regarding data packets are transmitted at block 408. Initially, control messages are used to transfer relevant data about the impending transfer of data packets created at block 404. In the context of advertising system 101, communication manager 204 implemented by networked server 103 is responsible for creating and transmitting messages such as the InitiateSession message and/or the StartTransmission message to portable device 105. Control messages may be transmitted via communication network(s) identified at block 406, or via other communication networks 110. Once portable device 105 has received relevant data about the impending transfer of data packets, it is ready to receive data packets.

At block 410, the data packets are asynchronously transmitted to portable device 105 via the communication network(s) identified at block 406, prior to the time at which the set of digital advertisements is scheduled for presentation. The data packets may be further encapsulated (by network interfaces 206 implemented by networked server 103, for example) for transmission via communication networks 110. For example, as applicable, the data packets may be further encapsulated using a network layer protocol such as TCP/IP for transmission over the Internet, a GPRS protocol for transmission over the cellular network, a WiFi protocol for transmission over the WLAN, or MPE for transmission over a DVB-H bearer. Then, the further encapsulated data packets are transmitted via a data link layer interface such as the Ethernet, and/or modulated onto a carrier for transmission across a physical medium to portable device 105. Data packets may be broadcast, unicast, or multicast, using in-band or out-of-band channels or techniques, to portable device 105. If more than one communication network 110 is used, each communication network may concurrently transmit data packets to portable device 105 to ensure that all of the data packets are transmitted in a timely fashion.

As indicated by the dotted-line arrow returning to block 408, additional messages, such as control messages, regarding data packets may be transmitted. In the context of advertising system 101, implementations of communication manager 204 in both networked server 101 and portable device 105 may create and transmit additional messages (or optional acknowledgements associated therewith) such as the TerminateSession message, the TransmissionComplete message, or the FailedTransmission message. Such additional control messages may be transmitted via communication network(s) identified at block 406, or via other communication networks 110.

The set of digital advertisements is reconstructed from the data packets received by portable device 105, as indicated at block 412. Initially, portable device 105 examines one or more control messages, such as the InitiateSession message, to identify the communication network(s) 110 via which data packets will be received, and other relevant information about the impending transfer of data packets. As data packets are received, packet data handler 205 within portable device 105 decrypts the data packets (if necessary), and handles the contents (for example, places data units in order, because there is generally no packet arrival order guarantee) based on the information within the data packets and/or previously received control messages. There is generally no underlying error correction or detection—portable device 105 may use standard error detection techniques, such as TCP/IP techniques, to ensure that data packets are error-free and/or to identify missing or corrupted data packets. Other error detection techniques are possible. For example, broadcast networks may use a forward error correction (“FEC”) scheme, such as Raptor, Reed Soloman, or another FEC scheme.

As indicated by the dotted-line arrow returning to block 408, additional messages, such as control messages, regarding the receipt of data packets may be transmitted. In the context of advertising system 101, implementations of communication manager 204 in both networked server 101 and portable device 105 may create and transmit additional messages (or optional acknowledgements associated therewith) such as the TerminateSession message, the TransmissionComplete message, or the FailedTransmission message. Such additional control messages may be transmitted via communication network(s) identified at block 406, or via other communication networks 110. Delivery confirmation logic implemented within portable device 105 may determine how to handle the success or failure of certain transmissions. In some cases, simply waiting for a re-transmission of one or more data packets is possible. Alternatively, a FailedTransmission message may be sent via any desirable communication network. Generally, the absence of a FailedTransmission message implies that all data packets were successfully received by the portable device 105. If a FailedTransmission message is sent, it is desirable to acknowledge the message. It is appreciated that the broadcast nature of certain network architectures may prevent retransmission of lost packets using the same connection requiring alternate communication networks to be employed.

It is not necessary that communications from portable device 105 be formatted in accordance with the predetermined packet data communication protocol—in general, any suitable protocol (such as a web-based protocol) may be used. When messages are sent by portable device 105 via one or more communication networks transmitting data packets, however, it is not generally desirable for such messages to be sent while data packets are being received, because of the potential increase in network traffic. Certain exceptions may be sensible, such as TerminateSession messages canceling a distribution session, or FailedTransmission messages reporting errors. It should also be noted that the cancellation of a distribution session by portable device 105 is generally only possible if portable device is not receiving data packets as part of a group. When data packets are received as part of a group, it is desirable for portable device to silently drop off of a distribution session, rather than to send a TerminateSession message.

Upon completion or termination of a specific advertising distribution session, distribution session records 222 (shown in FIG. 2 within data repository 208), which summarize pertinent information about the distribution session (such as digital advertisements or metadata transmitted, devices to which advertising was transmitted, communication network(s) via which transmission occurred, distribution dates, and the like), may be created and managed by advertising system 101 in networked server 103 or portable device 105.

Blocks 414, 416, and 418 represent optional acts associated with the presentation of digital advertising content 102, and the creation, management, and use of advertising consumption data 220 and other data. At shown at block 414, digital advertising content 102 is presented to user 106 (via portable device 105 or a device accessible via portable device 105). Advertising presentation systems and techniques are not discussed in detail herein. User consumption of the digital advertising content is monitored, at block 416, and at block 418, advertising consumption data 220 is generated. In the context of advertising system 101, implementations of advertising consumption manager 207 in both networked server 101 and portable device 105 are responsible for the creation and handling of advertising consumption data 220. Advertising consumption data 220 may be used locally and/or transmitted (via one or more communication networks 110, using the packet data communication protocol or other protocols or techniques) to another location, such as an ad watch aggregation server or service. Advertising consumption data 220 may be used for various commercial and informational purposes. For example, the data may be stripped of identifying information and sold or otherwise monetized. Examples of advertising consumption data 220 and other collected data useful for selecting current and future digital advertisements and for other commercial and informational purposes include but are not limited to data relating to: user location (such as general geographic location or proximity to certain landmarks); time of day; interactivity information such as user click-through information; program content preferences; payment preferences used in connection with a particular portable device; and general portable device usage (such as information regarding stored data or completed calls).

The advertising systems and techniques described herein enable digital advertising content to be reliably distributed to targeted portable devices separately from program content. The features of the systems and techniques described herein are usable by, and commercially beneficial to, content providers, network operators, advertisers, and users of portable devices—users can receive digital advertising content from a variety of providers and/or network operators almost anywhere their portable devices have network access, and information regarding users' consumption of digital advertising content is readily collected and used. Advertising techniques such as the utilization of interactive advertising, the use of mixed formats and alternative media types, and the insertion of up-to-date advertising are made possible. In one scenario, a video advertisement can be presented in conjunction with an audio broadcast, or a graphics slide show can be synchronized to a video stream. For example, in addition to relevant metadata (such as album art, artist information, track length, and the like) that is shown by some portable media players in conjunction with audio programming, such portable media players may also be configured to present visual advertisements. In another scenario, current, customized advertising can be provided as users play back recorded program content.

With continued reference to FIGS. 1-4, FIG. 5 is a block diagram of an exemplary configuration of an operating environment 500 in which all or part of advertising system 101 and/or the methods shown and discussed in connection with FIG. 4 may be implemented or used. Operating environment 500 is generally indicative of a wide variety of general-purpose or special-purpose computing environments, and is not intended to suggest any limitation as to the scope of use or functionality of the system(s) and methods described herein. For example, operating environment 500 may be a portable device such as a mobile phone, a personal digital assistant, a personal computer, a personal audio or video player, a computer/television device, a set-top box, a hard-drive storage device, a video camera, a DVD player, a cable modem, a local media gateway, a device temporarily or permanently mounted in transportation equipment such as a wheeled vehicle, a plane, or a train, or another type of known or later developed portable device. Operating environment 500 may also be a type of networked server, or any aspect thereof. Such a server may be part of a distributed computing network, and may be used to implement, host, or proxy a web service in whole or in part.

As shown, operating environment 500 includes processor 502, computer-readable media 504, specialized hardware 530, input interface(s) 516, output interface(s) 518, and network interface(s) 206. One or more internal buses 520, which are widely available elements, may be used to carry data, addresses, control signals and other information within, to, or from operating environment 500 or elements thereof. Computer-executable instructions 506 are shown as being stored on computer-readable media 504, along with digital advertising content 102, advertising distribution criteria 216, network selection criteria 218, advertising consumption data 220, and distribution session records 222.

Processor 502, which may be a real or a virtual processor, controls functions of operating environment 500 by executing computer-executable instructions 506. Processor 502 may execute instructions 506 at the assembly, compiled, or machine-level to perform a particular process.

Computer-readable media 504 represent any number and combination of local or remote devices, in any form, now known or later developed, capable of recording, storing, or transmitting computer-readable data. In particular, computer-readable media 504 may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; a paper tape; a punch card; or any combination thereof. Computer-readable media 504 may also include transmission media and data associated therewith. Examples of transmission media/data include, but are not limited to, data embodied in any form of wireline or wireless transmission, such as packetized or non-packetized data carried by a modulated carrier signal.

Computer-executable instructions 506 represent any signal processing methods or stored instructions. Generally, computer-executable instructions 506 are implemented as software components according to well-known practices for component-based software development, and encoded in computer-readable media (such as computer-readable media 504). Computer programs may be combined or distributed in various ways. Computer-executable instructions 506, however, are not limited to implementation by any specific embodiments of computer programs, and in other instances may be implemented by, or executed in, hardware, software, firmware, or any combination thereof.

As shown, certain computer-executable instructions 506 implement advertising distribution management functions 512, which implement aspects of advertising distribution manager 202 (shown in FIG. 2); certain computer-executable instructions 506 implement communication management functions 514, which implement aspects of communication manager 204, including packet data handler 205 and network interfaces 206; and certain computer-executable instructions 506 implement advertising consumption management functions 517, which implement aspects of advertising consumption manager 207.

Input interface(s) 516 are physical or logical elements that facilitate receipt of input to operating environment 500. Input may be received using any type of now known or later-developed physical or logical elements, such as user interfaces, remote controls, displays, mice, pens, styluses, trackballs, keyboards, microphones, scanning devices, and all types of devices that are used input data.

Output interface(s) 518 are physical or logical elements that facilitate provisioning of output from operating environment 500. Output may be provided using any type of now known or later-developed physical or logical elements, such as user interfaces, displays, printers, speakers, disk drives, and the like.

Network interface(s) 206 (discussed in more detail above, in connection with FIG. 2) are one or more physical or logical elements such as connectivity devices or computer-executable instructions, that enable communication by operating environment 500 via one or more protocols or techniques, at one or more layers of the OSI Internetworking Model.

Specialized hardware 530 represents any hardware or firmware that implements functions of operating environment 500. Examples of specialized hardware 530 include tuners, video or audio encoder/decoders (“CODECs”), application-specific integrated circuits, buffers, demultiplexors, decryptors, and the like.

It will be appreciated that particular configurations of operating environment 500 or advertising system 101 may include fewer, more, or different components or functions than those described. In addition, functional components of operating environment 500 or advertising system 101 may be implemented by one or more devices, which are co-located or remotely located, in a variety of ways.

Various aspects of advertising systems and techniques have been described. Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

1. A method for providing digital advertising to a portable device, the portable device configured to receive digital data via a plurality of communication networks, the method comprising:
identifying digital advertising content for presentation;
identifying at least one communication network from the plurality of communication networks, the identified communication network selected based on an evaluation of predetermined communication network selection criteria; and
arranging for the portable device to asynchronously receive the digital advertising content via the identified communication network.

2. The method according to claim 1, wherein the step of arranging for the portable device to asynchronously receive the digital advertising content occurs prior to a time at which the digital advertising content is scheduled for presentation, and wherein the digital advertising content is received separate from program content associated with the digital advertising content.

3. The method according to claim 1, wherein the predetermined communication network selection criteria are selected from the group consisting of: communication network availability; communication network speed; communication network bandwidth; communication network usage level; and communication network usage cost.

4. The method according to claim 1, wherein the digital advertising content comprises one of a digital advertisement and metadata associated with the digital advertisement.

5. The method according to claim 1, wherein the plurality of communication networks are selected from the group consisting of: digital broadcast networks; wide-area networks; and wireless local area networks.

6. The method according to claim 5, wherein the wide-area networks are selected from the group consisting of: General Packet Radio Service (“GPRS”)-enabled networks; Evolution Data Only (“EV-DO”)-enabled networks; Data Over Cable Service Interface Specification (“DOCSIS”)-enabled networks; the Internet; High Speed Downlink Packet Access (“HSDPA”)-enabled networks; Universal Mobile Telecommunication System (“UMTS”)-enabled networks; Enhanced Data rates for Global Evolution (“EDGE”)-enabled networks; and digital broadcast networks configured for datacasting.

7. The method according to claim 1, wherein the step of identifying digital advertising content comprises
based on a predetermined rule, arranging a plurality of digital advertisements into a set of digital advertisements,
ascertaining a portable device identifier associated with the portable device, and
associating the set of digital advertisements with the portable device identifier.

8. The method according to claim 1, wherein the portable device is a member of a predetermined group, and wherein the mobile communication identifier comprises an identifier associated with the predetermined group.

9. The method according to claim 1, wherein the step of identifying at least one communication network comprises
evaluating the predetermined network selection criteria with respect to each of the plurality of communication networks, and
based on the evaluation of the predetermined network selection criteria, selecting at least one communication network for transmitting the digital advertising content, and
wherein the step of arranging for the portable device to asynchronously receive the digital advertising content comprises asynchronously transmitting the digital advertising content to the portable device via the selected communication network.

10. The method according to claim 9, wherein the step of selecting at least one communication network comprises selecting a first communication network and a second communication network for transmitting the digital advertising content, and
wherein the step of asynchronously transmitting the digital advertising content to the portable device comprises asynchronously transmitting at least a portion of the digital advertising content to the portable device via the first communication network, and concurrently asynchronously transmitting at least a portion of the digital advertising content to the portable device via the second communication network.

11. The method according to claim 1, wherein step of arranging for the portable device to asynchronously receive the digital advertising information comprises
ascertaining a destination address associated with the portable device, the destination address selected from the group consisting of a unique destination address associated with the portable device, the networks to be traversed, and a group destination address, and
using a predetermined packet data communication protocol, transmitting the digital advertising content to the portable device.

12. The method according to claim 1, wherein the step of identifying at least one communication network comprises receiving a message via at least one communication network, the message including information regarding the transmission of the digital advertising content by the at least one communication network.

13. The method according to claim 12, wherein the step of arranging for the portable device to asynchronously receive the digital advertising information comprises
receiving a plurality of data packets sent using a predetermined packet data communication protocol via the identified communication network,
based on the plurality of data packets, re-constructing the digital advertising content to form re-constructed digital advertising content, and
storing the re-constructed digital advertising content in a memory associated with the portable device.

14. The method according to claim 1, further comprising:
presenting the digital advertising content to a user;
monitoring user consumption of the presented digital advertising content;
generating consumption data based on the step of monitoring; and
transmitting the consumption data to a data collection service,
wherein the consumption data is used for selecting other digital advertising content for presentation to the user.

15. The method according to claim 14, wherein the consumption data is selected from the group consisting of: user location, user payment information, user program content selection, time of day, interactivity data, and portable device usage information.

16. The method according to claim 1, further comprising:
requesting an update of the digital advertising content based on one of an expiration date associated with the digital advertising content and a discovery of missing digital advertising content.

17. A computer-readable medium encoded with computer-executable instructions for performing the steps recited in claim 1.

18. A system for providing digital advertising to a portable device, the portable device configured to receive digital data via a plurality of communication networks, the system comprising:
an advertisement distribution manager configured to identify digital advertising content for presentation;
a communications manager responsive to the advertisement distribution manager, the communications manager configured to
identify at least one communication network from the plurality of communication networks, the identified communication network selected based on an evaluation of predetermined communication network selection criteria, and
arrange for the portable device to asynchronously receive the digital advertising content via the at least one communication network; and
an advertisement consumption manager configured to monitor presentation of digital advertising content to a user, and to generate consumption data based on user consumption of presented digital advertising content.

19. The system according to claim 18, wherein the system comprises a client-side operating environment implemented within the portable device.

20. The system according to claim 18, wherein the system comprises a server-side operating environment implemented by a server within a wide-area network.
